(19) United States
(12) Patent Application Publication
(10) Pub. No.: US 2010/0027933 A1
(43) Pub. Date: Feb. 4, 2010

(54) NEEDLE BEARING

(75) Inventors: Franziska Locke, Bad Kissingen (DE); Christian Schulte-Noelle, Bamberg (DE); Werner Trojahn, Niederwerrn (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, HERZOGENAURACH (DE)

(21) Appl. No.: 12/447,188

(22) PCT Filed: Oct. 23, 2007
(86) PCT No.: PCT/DE2007/001900

§ 371 Date: Jul. 1, 2009

(30) Foreign Application Priority Data
Oct. 25, 2006 (DE) 10 2006 050 122.5

(51) Int. Cl. F16C 19/44

(52) U.S. Cl. 384/565

(57) ABSTRACT

The invention provides a needle bearing which has an extraordinarily large number of contact points and allows a long life to be expected even in a corrosive and/or hydrogen-containing working atmosphere. This is achieved by means of a needle bearing which has a bearing ring with a hardened austenitic steel which has a total carbon and nitrogen content of from 0.8 to 1.2% by weight and needles which roll on a bearing surface of the bearing ring and are composed of a ceramic whose surface defects are smaller than 40 μm.

### FIELD OF THE INVENTION

The invention concerns the field of hybrid rolling bearings, and relates to a needle bearing having at least one bearing ring.

In principle, needle bearings of this type have been known and commercially available for a long time. Needle bearings of this type are usually provided with two bearing rings—an inner bearing ring (so-called inner race) and an outer bearing ring (outer race) each with a raceway for the rolling bodies (cylindrical rollers or needles). However, it is also possible for one raceway to be formed on one of the components to be borne, for example a hub, and for only the corresponding raceway to be formed on a bearing ring. Within the context of the present invention, the term “needle” encompasses cylindrical rolling bodies, preferably needle-shaped rolling bodies which have a very thin diameter in relation to their length.

A need for particularly efficient needle bearings has arisen as a result of ever increasing demands with respect to the performance of rolling bearings, on the one hand, and more demanding or new operating conditions, in particular in highly corrosive environments or in a hydrogen-containing atmosphere, on the other hand. To date, it has not been possible to meet this need in a satisfactory manner.

There have in fact previously been attempts to use martensitically hardenable steels (e.g. Cronidur 30, Energietechnik, Essen) as materials for bearing rollers and bearing rings. Although these steels have a sufficient hardenability, they are not sufficiently corrosion-resistant for particularly demanding fields of use and, in addition, tend to become brittle in a hydrogen-containing atmosphere. These steels are also magnetic, and this may lead to the undesirable attachment of abraded metallic material or the like. To date, it has not been possible to produce needles suitable for needle bearings from this material.

Against this background, the object of the invention is to provide a needle bearing which has an extremely high load rating and has a long service life even in a corrosive and/or hydrogen-containing operating atmosphere.

According to the invention, this object is achieved by means of a needle bearing having at least one bearing ring consisting of a hardened austenitic steel with a total carbon and nitrogen content of from 0.8 to 1.2% by weight, and having needles which roll on a running surface of the bearing ring and are made from a ceramic with surface defects which are smaller than 40 μm.

One essential aspect of the invention is the use of nitrogen/carbon austenites which contain approximately 0.8 to 1.2% by weight carbon and nitrogen and form a sufficiently hardenable steel grade. To be precise, this material makes it possible to provide the running surfaces of bearing rings with hardnesses of above 50 Rockwell Cone (HRC). As compared with martensitically hardenable steels, the austenitic steel is distinguished by a significantly higher corrosion resistance and resistance to a hydrogen-containing atmosphere.

This provides a hybrid needle bearing which has outstanding running properties and is also distinguished by good running in the case of inadequate lubrication, while having a high load setting.

The needles may preferably consist of silicon nitride, silicon oxide, aluminum oxide or zirconium oxide. These materials form ceramics with outstanding rolling body properties, it being possible to limit the permissible surface defects to less than 40 μm in a reliable and relatively simple manner. In this context, surface defects are to be understood as meaning any openings in the surface or foreign inclusions.

The bearing rings can preferably be hardened by cold-working. The cold-working can particularly preferably be carried out by deep-drawing. For this purpose, further preference is given to providing disks as the starting workpieces, these disks having a wall thickness of from 2 to 20 mm after the deep-drawing.

According to an advantageous configuration of the invention, the bearing ring or bearing rings is or are provided with particularly good strength values by heat-treating them at a temperature of above 400° C., particularly preferably at temperatures of from 400° C. to 500° C., after the cold-working. Depending on the mass of the bearing rings, the duration of the heat treatment is usually approximately 1 to 3 hours. The cold-working (e.g. by means of deep-drawing) and the subsequent age-hardening make it possible to produce bearing rings having particularly good strength values and a hardness of above 50 HRC.

The ceramic needles, for example made from silicon nitride, may be produced by cold-pressing, subsequent sintering and hot isostatic pressing (HIP). The ceramic needles produced in this way may finally be subjected to a grinding process and/or gas pressure sintering.

1. A needle bearing
having at least one bearing ring consisting of a hardened austcnitic steel with a total carbon and nitrogen content of from 0.8 to 1.2% by weight, and
having needles which roll on a running surface of the bearing ring and are made from a ceramic with surface defects which arc smaller than 40 μm.

2. The needle bearing as claimed in claim 1, wherein the needles consist of silicon nitride.

3. The needle bearing as claimed in claim 1, wherein the needles consist of silicon oxide.

4. The needle bearing as claimed in claim 1, wherein the needles consist of aluminum oxide.

5. The needle bearing as claimed in claim 1, wherein the needles consist of zirconium oxide.

6. The needle bearing as claimed in claim 1, wherein the bearing ring is hardened by cold-working.

7. The needle bearing as claimed in claim 6, wherein the bearing ring is produced by deep-drawing.

8. The needle bearing as claimed in claim 1, wherein the bearing ring is treated by age-hardening at temperatures ranging from 400° C. to 500° C.
